(19) United States
(12) Patent Application Publication
(10) Pub. No.: US 2021/0394233 A1
(43) Pub. Date: Dec. 23, 2021

(54) PRINTED FOAM PANELS FOR ELECTRONIC DEVICES

(71) Applicant: HEWLETT-PACKARD DEVELOPMENT COMPANY, L.P., Spring, TX (US)

(72) Inventors: CHI HAO CHANG, TAIPEI CITY (TW); KUAN-TING WU, TAIPEI CITY (TW); CHENG-FENG LIAO, TAIPEI CITY (TW)

(21) Appl. No.: 17/418,429

(22) PCT Filed: Feb. 1, 2019
(86) PCT No.: PCT/US2019/016240

§ 371 Date: Jun. 25, 2021

(51) Int. Cl. B05D 7/00; B29C 44/02; H05K 5/02

(52) U.S. Cl. CPC B05D 7/57; B05D 2201/02; H05K 5/0213; B29C 44/022

(57) ABSTRACT

The present disclosure is drawn to printed foam panels for electronic devices. In one example, a printed foam panel for an electronic device can include a substrate, a primer layer on the substrate, a foam pattern on the primer layer, and a clear coating layer on the foam pattern. The foam pattern can cover a first portion of the substrate and leave a second portion uncovered. The foam pattern can include a printed pattern of a foaming composition including a photoacid generator compound and a metal carbonate activated to form the foam pattern.

### BACKGROUND

The use of personal electronic devices of all types continues to increase. Cellular phones, including smartphones, have become nearly ubiquitous. Tablet computers have also become widely used in recent years. Portable laptop computers continue to be used by many for personal, entertainment, and business purposes. For portable electronic devices in particular, much effort has been expended to make these devices more useful and more powerful while at the same time making the devices smaller, lighter, and more durable. Power management, heat management, and miniaturization of components are several of the considerations involved in designing portable electronic devices. The aesthetic design of personal electronic devices is also of concern in this competitive market.

### BRIEF DESCRIPTION OF THE DRAWING

FIG. 1 is a cross-sectional view illustrating an example printed foam panel for an electronic device in accordance with the present disclosure;

FIG. 2 is a cross-sectional view illustrating another example printed foam panel for an electronic device in accordance with the present disclosure;

FIG. 3 is a cross-sectional view illustrating yet another example printed foam panel for an electronic device in accordance with the present disclosure;

FIG. 4 is a top down view of yet another example printed foam panel for an electronic device in accordance with the present disclosure;

FIG. 5 is a top down view of another example printed foam panel for an electronic device in accordance with the present disclosure;

FIG. 6 is a cross-sectional view of still another example printed foam panel for an electronic device in accordance with the present disclosure;

FIG. 7 is an exploded view of an example electronic device in accordance with examples of the present disclosure; and

FIG. 8 is a flowchart illustrating an example method of making a printed foam panel for an electronic device in accordance with the present disclosure.

### DETAILED DESCRIPTION

The present disclosure describes printed foam panels for electronic devices. In one example, a printed foam panel for an electronic device can include a substrate, a primer layer on the substrate, a foam pattern on the primer layer, and a clear coating layer on the foam pattern. The foam pattern can cover a first portion of the substrate and leave a second portion uncovered, and the foam pattern can be generated from a printed pattern of a foaming composition including a photoacid generator compound and a metal carbonate activated to form the foam pattern. In some examples, the substrate can be a cover for an electronic device including aluminum, magnesium, carbon fiber, polypropylene, polycarbonate, polyethylene, polyamide, polyester, acrylonitrile-butadiene-styrene, or a combination thereof. In further examples, the substrate can be a flexible polymeric film including polyacrylic, polymethacrylic, polyethylene terephthalate, polyimide, polyurethane, polycarbonate, polyvinyl chloride, or a combination thereof. In other examples, the primer layer can include polyacrylic, polymethacrylic, polycarbonate, polyester, cyclic olefin copolymer, or a combination thereof. In some examples, the photoacid generator compound can include a salt including: an anion including CF₃SO₃⁻, SbF₆⁻, AsF₆⁻, or PF₆⁻, and a cation including a sulfonium compound, a phosphonium compound, an oxonium compound, an iodonium compound, an ammonium compound, or a diazonium compound. In still further examples, the metal carbonate can include sodium carbonate, sodium bicarbonate, lithium carbonate, magnesium carbonate, magnesium bicarbonate, potassium carbonate, potassium bicarbonate, zinc carbonate, barium carbonate, barium bicarbonate, calcium carbonate, calcium bicarbonate, chromium carbonate, chromium bicarbonate, nickel carbonate, nickel bicarbonate, iron carbonate, iron bicarbonate, titanium carbonate, titanium bicarbonate, or a combination thereof. In yet further examples, the foam pattern can also include polyacrylic, polyurethane, urethane acrylates, acrylic acrylates, epoxy acrylates, or a combination thereof. In a certain example, the clear coating layer can include a transparent radiation-cured polymer. In another example, the printed foam panel can also include a colorant coating layer between the primer layer and the foam pattern, wherein the colorant coating layer includes a pigment and a binder.

The present disclosure also extends to electronic devices. In one example, an electronic device can include an electronic component and a cover enclosing the electronic component. The cover can include a substrate, a primer layer on the substrate, a foam pattern on the primer layer, and a clear coating layer on the foam pattern. The foam pattern can cover a first portion of the substrate and leave a second portion uncovered. The foam pattern can be generated from a printed pattern of a foaming composition including a photoacid generator compound and a metal carbonate activated to form the foam pattern. In another example, the electronic component can generate heat and the first portion where the foam pattern is located can insulate the cover from the heat. In yet another example, the foam pattern can be visible on an exterior surface of the cover.

The present disclosure also extends to methods of making printed foam panels for electronic devices. In one example, a method of making a printed foam panel for an electronic device can include applying a primer composition to a substrate to form a primer layer and printing a foaming composition on the primer layer to form a printed pattern of the foaming composition. The printed pattern can cover a first portion of the substrate with the foaming composition and leaves a second portion uncovered, and the foaming composition can be generated from a photoacid generator compound and a metal carbonate. The method can further include applying radiation to the foaming composition to form a foam pattern from the foaming composition, and applying a clear coating on the foam pattern. In one example, the foaming composition can be printed by inkjet printing, rotogravure printing, screen printing, 3D printing, or a combination thereof. In a further example, the method can also include laminating an adhesive layer and a release film to a bottom surface of the substrate, wherein the substrate includes a polymer film.

In addition to the examples described above, the printed foam panels, the electronic devices, and methods will be described in greater detail below. It is also noted that when discussing the printed foam panels, electronic devices, and methods, these relative discussions can be considered applicable to the other examples, whether or not they are explicitly discussed in the context of that example. Thus, for example, in discussing a primer layer related to a printed foam panel, such disclosure is also relevant to and directly supported in the context of the electronic devices and methods described herein, and vice versa. It is also understood that terms used herein will take on their ordinary meaning in the relevant technical field unless specified otherwise. In some instances, there are terms defined more specifically throughout or included at the end of the present disclosure, and thus, these terms are supplemented as having a meaning described herein.

### Printed Foam Panels

The printed foam panels for electronic devices described herein can have several useful features. First, the foam panel itself can be formed or generated by printing a pattern of a foaming composition that includes a photoacid generator compound and a metal carbonate. Stated another way, the foam panel is a reaction product of the photoacid generator compound and the metal carbonate, and in some instances, the reaction is initiated by application of electromagnetic radiation from a radiation source, such as a photo energy source, e.g., UV energy. In some examples, these compositions can be liquid solutions or suspensions that can conveniently be printed using a variety of printing methods, such as inkjet printing, screen printing, gravure printing, and others. The foaming composition can be printed in a desired pattern on a substrate. The composition can then be exposed to appropriate radiant energy to activate the photoacid generator compound, which in turn can react with the metal carbonate to form foam. In particular, the generated acids can react with the metal carbonate to form gas that can fill the cells of the foam and cause the foam to expand. In some examples, the foaming composition can also include a polymer that can make up the solid portion of the foam including the cell walls. Because the foaming composition can be easily printed in any desired pattern, the printed foam panels can be easily customized to include foam in any desired locations and patterns on the substrate.

In some cases, the foam panel can be used for heat management in an electronic device. The foam can be an effective thermal insulator. In certain examples, the foam pattern can be designed to insulate electronic components that generate heat, such as processors, batteries, memory, hard drives, and so on. The foam pattern can reduce hot spots on the exterior surface of the electronic device. This can increase comfort for the user, especially for electronic devices that often come in contact with a body of a user such as laptops, tablet computers, and mobile phones. In further examples, the foam can shield heat-sensitive components of the electronic device. This can reduce heat-related issues in the device and increase the operational lifetime of the device. In some examples, the printed foam panels described herein can help extend the lifetime of liquid crystal display panels, light emitting diodes, central processing units, batteries, and other electronic components. In further examples, the printed foam panels can reduce the risk of battery explosion, prevent skin burning, increase data loading speed, or increase power efficiency. Besides heat management, the foam may also be useful as a shock absorbing material or rigidity enhancing material. Thus, the foam can be used to mechanically protect components of the electronic device in addition to providing thermal insulation.

In still further examples, the printed foam panels described herein can be used decoratively. For example, printed foam panels can be designed with the foam pattern on the exterior of an electronic device so that the foam pattern is visible to users. The foam pattern can have any desired decorative design. Additionally, the foam can be formed with a greater thickness in certain areas by printing greater amounts of foaming composition (e.g., by ink jetting more drops per unit area or by printing multiple coats one over another). By controlling the thickness of the foam in various locations, the foam pattern can be designed to show a three-dimensional texture or image. Many different decorative images and patterns can be formed from foam in this way. In certain examples, a foam panel on an exterior surface of an electronic device can serve purposes, such as decoration, thermal insulation, and/or shock absorbance.

The foaming composition can be printed on a variety of substrates. In some examples, the foaming composition can be printed onto a cover for an electronic device. Covers for electronic devices can be made of a variety of different materials, such as plastic, metal, glass, carbon fiber, or others. As used herein, “cover” refers to the exterior shell or housing of an electronic device. In other words, the cover contains the internal electronic components of the electronic device. The cover is an integral part of the electronic device. The term “cover” is not meant to refer to the type of removable protective cases that are often purchased separately from an electronic device (especially smartphones and tablets) and placed around the exterior of the electronic device.

In other examples, the printed foam panels described herein can be formed on a plastic film and then applied to a desired surface, such as a cover for an electronic device. In certain examples, the foaming composition can be printed on a polymer film substrate, and an adhesive layer can be added on a back surface of the polymer film substrate. The film can then be adhered to a cover for an electronic device or another surface as desired.

In further detail, it is noted that the spatial relationship between layers is often described herein as positioned or applied “on” or “over” another layer. These terms do not infer that this layer is positioned directly in contact with the layer to which it refers, but could have intervening layers therebetween. That being stated, a layer described as being positioned on or over another layer can be positioned directly on that other layer, and thus such a description finds support herein for being positioned directly on the referenced layer.

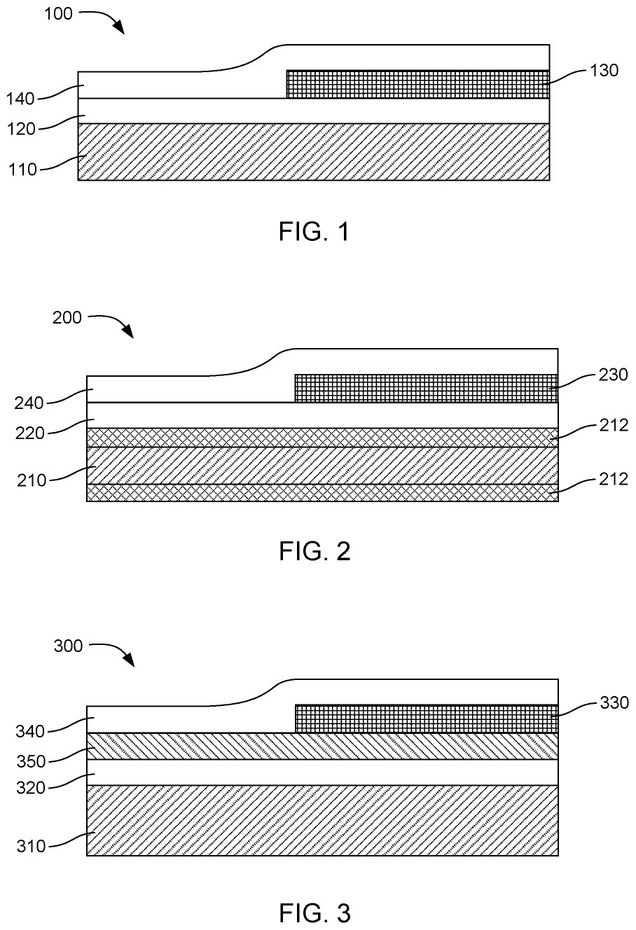

With this description in mind, FIG. 1 shows a cross-sectional view of an example printed foam panel 100 for an electronic device in accordance with the present disclosure. The printed foam panel includes a substrate 110, a primer layer 120 on the substrate, a foam pattern 130 on the primer layer, and a clear coating layer 140 on the foam pattern. The foam pattern in this example is located over one area of the substrate, while leaving another area of the substrate uncovered by the foam. In certain examples, the foam pattern may be located in a particular place to provide thermal insulation to a particular electronic component.

FIG. 2 shows a cross-sectional view of another example printed foam panel 200 in accordance with examples of the present disclosure. This example includes a substrate 210 having micro-arc oxidation layers 212 on the surfaces of the substrate. Certain metal substrates can be treated by micro-arc oxidation to enhance the surface properties of the metal. In particular, micro-arc oxidation treatment can be used with magnesium or magnesium alloy substrates in some examples. The printed foam panel also includes a primer layer 220 on the micro-arc oxidation layer of the substrate. A foam pattern 230 is printed on the primer layer, and a clear coating layer 240 is applied over the foam pattern.

FIG. 3 shows yet another cross-sectional view of an example printed foam panel 300 in accordance with examples of the present disclosure. In this example, the printed foam panel includes a substrate 310, a primer layer 320 on the substrate, and a colorant coating layer 350 on the primer layer. The colorant coating layer can include a pigment and a binder and can impart a desired color to the panel. In some examples, this colorant coating layer can be included in a decorative panel to be located on an exterior surface of a cover for an electronic device. This example also includes a foam pattern 330 on the colorant coating layer and a clear coating layer 340 over the foam pattern.

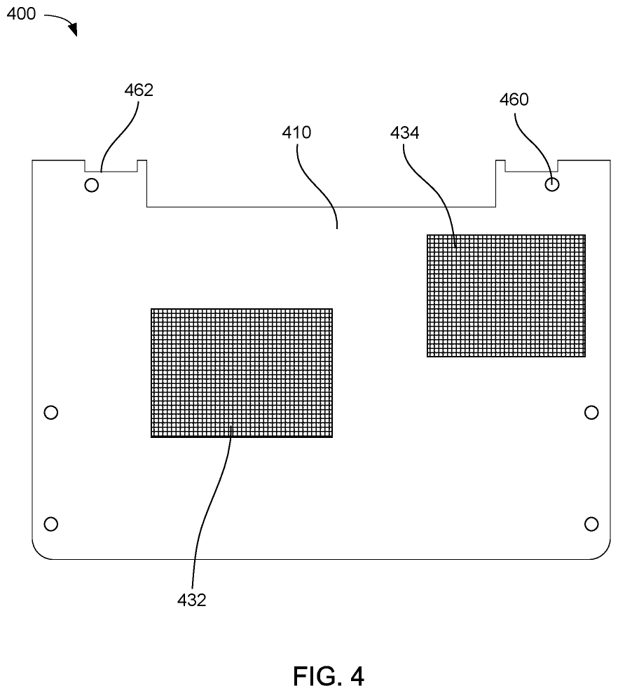

A more specific example of a printed foam panel is shown in FIG. 4. This example is a laptop bottom cover 400. The laptop bottom cover includes a cover substrate 410 having screw holes 460 and hinge recesses 462 to allow the laptop bottom cover to be assembled with other parts of the laptop. In this example, a foam pattern is printed on the cover substrate including a first foam section 432 and a second foam section 434. These foam sections can be located in specific locations to provide thermal insulation near components of the laptop that produce heat. For example, the foam sections may be located near a central processing unit, hard drive, graphics processing unit, and so on. Although not visible in the figure, the laptop bottom cover can also have a primer layer applied to the cover substrate and a clear coating layer applied over the foam pattern layer.

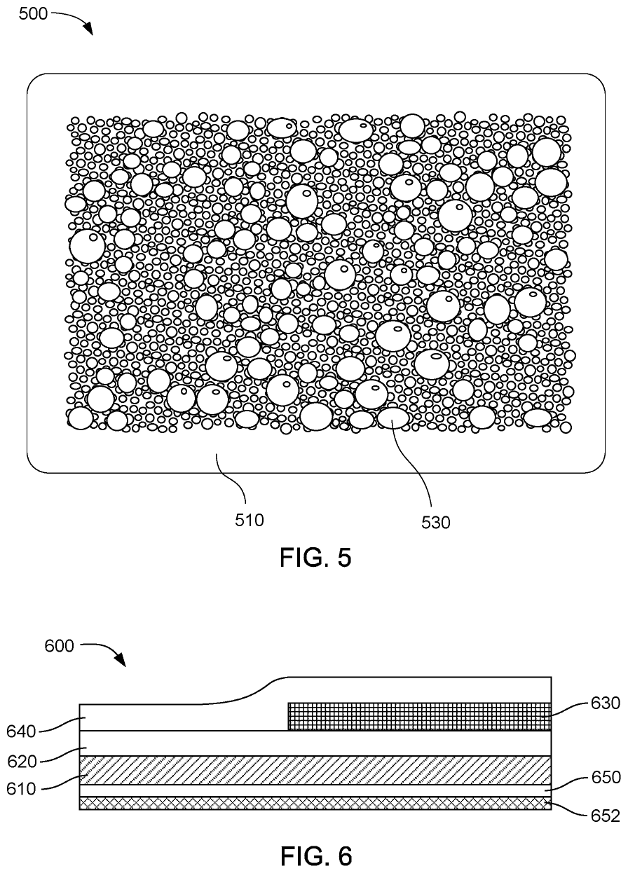

Another example printed foam panel is shown in FIG. 5. This example is a laptop monitor back cover 500. The laptop monitor back cover includes a cover substrate 510 and a foam pattern 530 printed on the cover substrate. The foam pattern in this example is a decorative pattern having the appearance of bubbles. As explained above, the foam pattern can be formed by printing a foaming composition using a variety of different printing methods. Therefore, any pattern or image can be printed in the foam pattern. The foam pattern can also have a three-dimensional characteristic because printing a greater amount of the foaming composition on a particular area can cause thicker foam to form in that area. Thus, the bubble pattern shown in FIG. 5 can have a three dimensional texture. Although not shown in the figure, this example can also include a primer layer applied to the cover substrate and a clear coating layer applied over the foam pattern layer.

In further examples, printed foam panels can be made with a flexible polymeric film as the substrate. In some such examples, this can produce a flexible film with a foam pattern that can be adhered to a variety of surfaces. In some cases, the flexible film can be designed to be adhered to an electronic device cover. FIG. 6 shows an example printed foam panel 600 with a flexible polymeric film substrate 610. A primer layer 620 is applied to the substrate. A foam pattern 630 is printed on the primer layer, and a clear coating layer 640 is applied over the foam pattern. Additionally, an adhesive layer 650 is applied on a surface of the polymer film substrate opposite from the primer layer. A release film 652 is included on the adhesive layer. The release film can be removed to expose the adhesive layer, and the foam panel can then be adhered to a desired surface. In some examples, flexible foam panels of this type can be manufactured using a roll-to-roll process.

### Electronic Devices

A variety of electronic devices can be made with covers having a printed foam panel as described herein. In various examples, such electronic devices can include various electronic components enclosed by the cover. As used herein, “encloses” or “enclosed” when used with respect to the covers enclosing electronic components can include covers completely enclosing the electronic components or partially enclosing the electronic components. Many electronic devices include openings for charging ports, input/output ports, headphone ports, and so on. Accordingly, in some examples the cover can include openings for these purposes. Certain electronic components may be designed to be exposed through an opening in the cover, such as display screens, keyboard keys, buttons, fingerprint scanners, cameras, and so on. Accordingly, the covers described herein can include openings for these components. Other electronic components may be designed to be completely enclosed, such as motherboards, batteries, sim cards, wireless transceivers, memory storage drives, and so on.

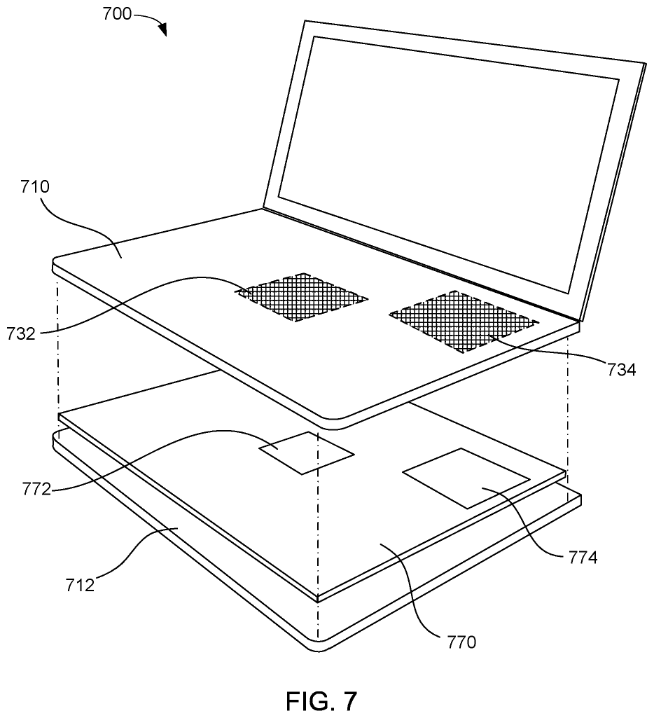

FIG. 7 shows an exploded view of an example electronic device in accordance with examples of the present disclosure. In this example, the electronic device is a laptop 700. The laptop includes a top cover 710, a motherboard 770, and a bottom cover 712. The bottom cover and top cover can be assembled with the motherboard enclosed between the top and bottom covers, as indicated by the dashed and dotted lines. In this example, the motherboard is an electronic component that is enclosed by the covers, and additionally many other electronic components can be attached to the motherboard. In this particular example, a central processing unit 772 and a hard disk 774 are shown on the motherboard. In order to provide thermal insulation for these components, the top cover has a foam pattern made up of a first foam section 732 positioned over the central processing unit and a second foam section 734 positioned over the hard disk. Although not shown in the figure, the top cover can also include a primer layer and a clear coating layer as in the other examples described herein.

In further examples, the electronic device can be a personal computer, a laptop, a tablet computer, a smartphone, a television, or a variety of other electronic devices. In some examples, the foam pattern can be located on the inside of the cover of the electronic device. As explained above, the foam can serve as thermal insulation and or as mechanical shock protection or rigidity enhancement. In other examples, the foam pattern can be visible on the outside of the cover of the electronic device. In some such examples, the foam pattern can be designed with an aesthetically appealing pattern or image, including three dimensional textured patterns and images. In certain examples, the foam pattern can serve as a decoration while at the same time serving as thermal insulation or mechanical protection for the electronic device.

### Methods of Making Printed Foam Panels

The printed foam panels described herein can be made by applying layers of various coating materials to a substrate. As explained above, the foam pattern can be made by printing a foaming composition that includes components that react together to generate foam. The components that react to generate foam can be a photoacid generator and a metal carbonate. In some cases, the methods can include irradiating this foaming composition with radiant energy to activate the photoacid generator. This can trigger the reaction between acid generated by the photoacid generator and the metal carbonate. In certain examples, the foaming composition can be a single composition that includes both the photoacid generator and the metal carbonate. Thus, both these ingredients can be printed together and then the photoacid generator can be activated by exposure to light. In other examples, the foaming composition can be printed in two separate parts. A first composition can include the photoacid generator and a second composition can include metal carbonate. These two compositions can be printed onto the same area of the substrate so that the photoacid generator and the metal carbonate can react together.

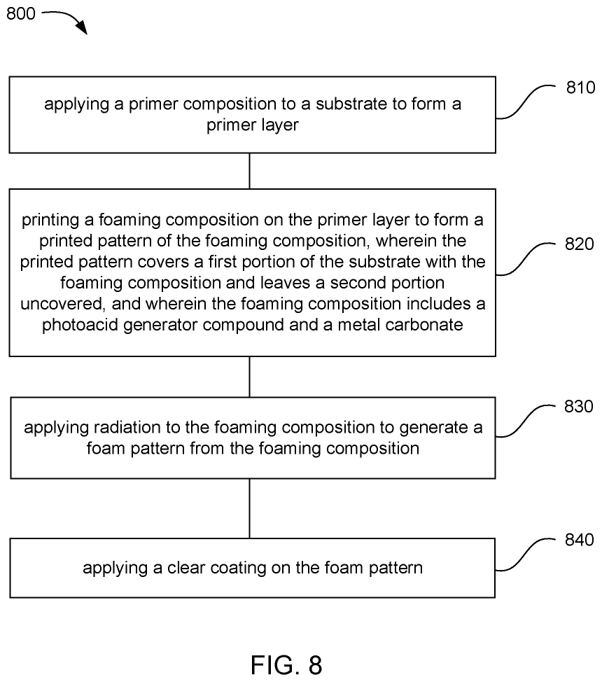

FIG. 8 is a flowchart of one example method 800 of making a printed foam panel for an electronic device. This method includes applying 810 a primer composition to a substrate to form a primer layer, and printing 820 a foaming composition on the primer layer to form a printed pattern of the foaming composition. The printed pattern can cover a first portion of the substrate with the foaming composition and leaves a second portion uncovered, and the foaming composition can be generated from or be a reaction product of a photoacid generator compound and a metal carbonate. The method can further include applying 830 radiation to the foaming composition to generate a foam pattern from the foaming composition, and applying 840 a clear coating on the foam pattern.

Different processes can be used to form the printed foam panels depending on the type of substrate. For example, when the substrate is a cover for an electronic device, then the process can include application methods suitable for use on a cover for an electronic device. In certain examples, a cover substrate can be coating with a primer by spray coating, dip coating, or another suitable coating method. A foaming composition can then be printed onto the cover substrate using a printer configured to print on the cover substrate. The printer can be an ink jet printer, gravure printer, screen printer, 3D printer, or another type of printing system. The clear coating layer can then be applied by spray coating, dip coating, or another suitable coating method.

In other examples, the printed foam panels can be formed with a flexible polymeric film substrate. These flexible printed foam panels can be made efficiently using a continuous roll-to-roll process in some examples. In such a process, a continuous roll of a polymeric film substrate can be fed through equipment for coating the various layer materials onto the polymeric film substrate. In certain examples, a primer composition can be applied to the polymeric film substrate by spray coating, knife coating, rod coating, curtain coating, or other coating methods suitable for roll-to-roll processes. The foaming composition can be printed by a printing method suitable for a roll-to-roll process, such as ink jet printing, rotogravure printing, and others. In further examples, the film can be exposed to a radiation source, e.g., a photo energy source such as a UV energy source, to activate the photoacid generator in the foaming composition. The clear coating layer can also be applied using a suitable coating method. In still further examples, the method of making the printed foam panel can also include laminating the polymeric film substrate with an adhesive layer and a release film on a bottom surface of the polymeric film substrate.

### Substrate

The substrate can include a variety of materials. In various examples, the substrate can be a cover for an electronic device or a flexible polymeric film. In some examples, the substrate can be a cover for an electronic device made of a rigid material such as plastic, carbon fiber, glass, metal, a composite, or a combination thereof. Non-limiting examples of rigid materials that can be used in the substrate include aluminum, magnesium, carbon fiber, glass, polypropylene, polycarbonate, polyethylene, polyamide, polyester, acrylonitrile-butadiene-styrene, and combinations thereof.

In certain examples, the substrate can include a light metal such as aluminum, magnesium, titanium, lithium, niobium, or an alloy thereof. In some examples, alloys of these metals can include additional metals, such as bismuth, copper, cadmium, iron, thorium, strontium, zirconium, manganese, nickel, lead, silver, chromium, silicon, tin, gadolinium, yttrium, calcium, antimony, zinc, cerium, lanthanum, or others. In a particular example, the substrate can be pure magnesium or an alloy including 99% magnesium or greater. In another particular example, the substrate can be made of an alloy including magnesium and aluminum. In a particular example, the substrate can be made from AZ31 alloy or AZ91 alloy.

In further examples, the substrate can include carbon fiber. In particular, the substrate can be a carbon fiber composite. The carbon fiber composite can include carbon fibers in a plastic material such as a thermoset resin or a thermoplastic polymer. Non-limiting examples of the polymer can include epoxies, polyesters, vinyl esters, and polyamides.

In various examples, the substrate can be formed by molding, casting, machining, bending, working, or another process. In certain examples, the substrate can be a chassis for an electronic device that is milled from a single block of metal or metal alloy. In other examples, an electronic device cover can be made from multiple panels. As an example, laptops sometimes include four separate pieces forming the cover of the laptop, with the electronic components of the laptop protected inside the cover. The four separate pieces of the laptop cover are often designated as cover A (back cover of the monitor portion of the laptop), cover B (front cover of the monitor portion), cover C (top cover of the keyboard portion) and cover D (bottom cover of the keyboard portion). In certain examples, one of these covers or more than one of these covers can include metal, metal alloy, carbon fiber, glass, plastic, and so on. These covers can be made by machining, casting, molding, bending, or by other forming methods. Other types of electronic device covers can also be the substrate referred to above, such as a smartphone, tablet, or television cover. These substrates can be made using the same forming methods.

The substrate is not particularly limited with respect to thickness. However, when the substrate is a cover for an electronic device, the thickness of the substrate chosen, the density of the material (for purposes of controlling weight, for example), the hardness of the material, the malleability of the material, the material aesthetic, etc., can be selected as appropriate for a specific type of electronics device, e.g., lightweight materials and thickness chosen for covers where lightweight properties may be commercially competitive, heavier more durable materials chosen for covers where more protection may be useful, etc. To provide some examples, the thickness of the substrate can be from about 0.5 mm to about 2 cm, from about 1 mm to about 1.5 cm, from about 1.5 mm to about 1.5 cm, from about 2 mm to about 1 cm, from about 3 mm to about 1 cm, from about 4 mm to about 1 cm, or from about 1 mm to about 5 mm, though thicknesses outside of these ranges can be used.

In further examples, a substrate may include more than one type of material. In certain examples, a substrate can include a plastic portion formed by insert molding. For example, a substrate can have a metal portion or a carbon fiber portion or a glass portion and an insert molded plastic portion. Insert molding involves placing the substrate portion into a mold, where a plastic material is then injection molded in the mold around the metal, carbon fiber, or glass. In some cases, the metal, carbon fiber, or glass substrate can include an undercut shape and the molten plastic can flow into the undercut during injection molding. When the plastic hardens, the undercut can provide a strong connection between the plastic and the other portion of the substrate.

In still further examples, the substrate can include a metal having a micro-arc oxidation layer on a surface thereof. Micro-arc oxidation, also known as plasma electrolytic oxidation, is an electrochemical process where the surface of a metal is oxidized using micro-discharges of compounds on the surface of the substrate when immersed in a chemical or electrolytic bath, for example. The electrolytic bath may include predominantly water with about 1 wt % to about 5 wt % electrolytic compound(s), e.g., alkali metal silicates, alkali metal hydroxide, alkali metal fluorides, alkali metal phosphates, alkali metal aluminates, the like, and combinations thereof. The electrolytic compounds may likewise be included at from about 1.5 wt % to about 3.5 wt %, or from about 2 wt % to about 3 wt %, though these ranges are not considered limiting. In one example, a high-voltage alternating current can be applied to the substrate to create plasma on the surface of the substrate. In this process, the substrate can act as one electrode immersed in the electrolyte solution, and the counter electrode can be any other electrode that is also in contact with the electrolyte. In some examples, the counter electrode can be an inert metal such as stainless steel. In certain examples, the bath holding the electrolyte solution can be conductive and the bath itself can be used as the counter electrode. A high direct current or alternating voltage can be applied to the substrate and the counter electrode. In some examples, the voltage can be about 200 V or higher, such as about 200 V to about 600 V, about 250 V to about 600 V, about 250 V to about 500 V, or about 200 V to about 300 V. Temperatures can be from about 20° C. to about 40° C., or from about 25° C. to about 35° C., for example, though temperatures outside of these ranges can be used. This process can oxidize the surface to form an oxide layer from the substrate material. Various metal or metal alloy substrates can be used, including aluminium, titanium, lithium, magnesium, and/or alloys thereof, for example. The oxidation can extend below the surface to form thick layers, as thick as 30 μm or more. In some examples the oxide layer can have a thickness from about 1 μm to about 25 μm, from about 1 μm to about 22 μm, or from about 2 μm to about 20 μm. Thickness can likewise be from about 2 μm to about 15 μm, from about 3 μm to about 10 μm, or from about 4 μm to about 7 μm. The oxide layer can, in some instances, enhance the mechanical, wear, thermal, dielectric, and corrosion properties of the substrate. The electrolyte solution can include a variety of electrolytes, such as a solution of potassium hydroxide. In some examples, the rigid substrate can include a micro-arc oxidation layer on one side, or on both sides.

In further examples, a metal substrate can be treated with a passivation treatment. In some examples, the passivation treatment can include dissolving a passivating compound in a solution and immersing the metal substrate in the solution to form a layer of the passivating compound on the metal substrate. Examples of passivation treatments can include chromate conversion coating, phosphate conversion coating, molybdate conversion coating, vanadate conversion coating, stannate conversion coating, and others.

In still further examples, the metal substrate can be treated by anodization. Anodization is a particular type of passivation process. When anodizing aluminum, for example, the aluminum metal is used as an anode submerged in an electrolyte solution and an electric current is passed through the solution. Oxygen is released at the anode surface, forming a buildup of aluminum oxide. Dyes can also be added during this process, which can penetrate beneath the surface of the aluminum oxide to make a durable colored surface.

In further examples, the substrate can include a flexible polymeric film. In some examples, the printed foam panel can be made by beginning with the polymeric film as a substrate and then the primer layer, foam pattern, clear top coat layer, and any other layers can be applied to the polymeric film. The printed foam panel may derive a majority of its strength and structural integrity from the polymeric film.

In some examples, the polymeric film can include polyacrylic, polymethacrylic, polyethylene terephthalate, polyimide, polyurethane, polycarbonate, polyvinyl chloride, or a combination thereof. In various examples, the polymeric film can be extruded, cast, compression molded, or prepared by any other method. In further examples, the polymeric film can have a thickness from about 10 μm to about 150 μm. In still further examples, the polymeric film can have a thickness from about 25 μm to about 100 μm or from about 30 μm to about 75 μm.

In further examples, the polymeric film can include an adhesive layer on a bottom surface of the polymeric film. The adhesive layer can be used to adhere the printed foam panel to a surface such as the surface of a cover of an electronic device. In some examples, the adhesive layer can have a thickness from about 1 μm to about 100 μm, from about 2 μm to about 50 μm, or from about 5 μm to about 30 μm. Non-limiting examples of adhesive materials that can be used include ethylene vinyl acetate copolymers, ethylene ethyl acrylate copolymers, ionomers, poly(ethyl acrylate), phenoxy resins, polyamides, polyesters, polyvinyl acetate, polyvinyl butyral, polyvinyl ethers, and others.

In some examples, the printed foam panel can include a removable release liner on the bottom face of the adhesive layer. The release liner can be peeled off before adhering the printed foam panel to a surface. In some examples, the release liner can include a transparent plastic film, such as a polyethylene terephthalate (PET) film or a polycarbonate (PC) film, for example. In some examples, the release liner can be siliconized by coating a surface of the film with a silicone compound. In another example, the release liner can be siliconized paper.

### Primer Layer

The primer layer can be formed by applying a primer composition to the substrate. In some examples, this primer layer can help the foam pattern adhere to the substrate. In certain examples, the primer layer can include a polymer such as a polyacrylic, a polymethacrylic, a polycarbonate, a polyester, a cyclic olefin copolymer, or a combination thereof. In some examples, the thickness of the primer layer can be from about 5 μm to about 100 μm or from about 5 μm to about 15 μm.

In a particular example, the substrate can be metal with a micro-arc oxidation layer and the primer layer can be applied over the micro-arc oxidation layer. In another example, a primer can be applied over a substrate that includes a metal portion and an insert molded plastic portion. The primer can increase adhesion and also fill in any gaps or uneven surfaces at the junction between the metal and the plastic.

In further examples, the substrate primer layer can include a polyurethane or polyurethane copolymer. In certain examples, the polyurethane or polyurethane copolymer can be formed by polymerizing a polyisocyanate and a polyol. Non-limiting examples of polyisocyanates that can be used include toluene diisocyanate, methylene diphenyl diisocyanate, 1,6-hexamethylene diisocyanate, isophorone diisocyanate, 4,4′-diisocyanato dicyclohexylmethane, trimethylhexamethylene diisocyanate, and others. The polyol can, in some examples, be a polyether polyol or a polyester polyol having a weight average molecular weight from about 100 Mw to about 10,000 Mw, from about 200 Mw to about 8,000 Mw, or from about 500 Mw to about 5,000 Mw. In certain examples, the polyol can be a diol that includes two hydroxyl groups.

In certain examples, the primer can include a moisture-cured polyurethane. Moisture-cured polyurethanes can include isocyanate-terminated prepolymers that can be cured with ambient water. In a particular example, the primer can include Airethane™ 1204 polyurethane or other Airethane™ 1000 series polyurethanes (Fairmont Industries).

In other examples, the primer can include an alkyd resin. Alkyd resins are thermoplastic resins made from polyhydric alcohols and polybasic acids or their anhydrides. In some examples, alkyd resins can be made by a polycondensation reaction of a polyol with a dicarboxylic acid or its anhydride. Non-limiting examples of other polybasic acids that can be used in alkyd resins include phthalic anhydride, isophthalic anhydride, maleic anhydride, fumaric acid, and others. Non-limiting examples of polyols that can be used in alkyd resins include glycerol, trimethylolethane, trimethylolpropane, pentaerythritol, ethylene glycol, and neopentyl glycol. In some examples, a monobasic acid can also be included in the reaction to modify the alkyd resin. In specific examples, the primer can include a resin from the DOMALKYD™ line of resins, such as DOMALKYD™ 4161 (Helios).

As mentioned above, in some examples the substrate can be a flexible polymeric film. A primer layer can also be applied over the polymeric film. In some examples, the primer layer can include a transparent polymer. Non-limiting examples of the transparent polymer can include polyacrylic, polymethacrylic, polycarbonate, polyester, cyclic olefin copolymer, or a combination thereof. In certain examples, the primer layer can consist of the transparent polymer, and thus the primer layer can be transparent.

In various examples, the primer layer can be applied to the polymeric film by co-extrusion, lamination, or as a liquid polymer or slurry that can be dried and/or cured after being applied to the polymeric film. Liquid or slurry primers can be applied by any suitable coating method, such as by spray coating, dip coating, rod coating, blade coating, and so on.

After applying the primer layer, in some examples a colorant coating layer can be applied over the primer layer before applying the foam pattern layer. The colorant coating layer can include, for example, colored paint in any desired color or combination of colors to impart a color to the printed foam panel. In some examples, the colorant coating layer can have a thickness from about 1 μm to about 30 μm or from about 10 μm to about 15 μm.

The colorant coating layer can include a pigment and a polymeric binder. Non-limiting examples of pigments used in the colorant coating layer can include carbon black, titanium dioxide, clay, mica, talc, barium sulfate, calcium carbonate, synthetic pigment, metallic powder, aluminum oxide, graphene, pearl pigment, or a combination thereof. The pigment can be present in the colorant coating layer in an amount from about 0.5 wt % to about 30 wt % with respect to dry components of the colorant coating layer, in some examples. In other examples, the amount of pigment can be from about 1 wt % to about 25 wt % or from about 2 wt % to about 15 wt % with respect to dry components of the colorant coating layer.

The polymeric binder included in the colorant coating layer with the pigment can include polyester, poly(meth)acrylic, polyurethane, epoxy, urethane (meth)acrylic, (meth)acrylic (meth)acrylate, epoxy (meth)acrylate, or a combination thereof. As used herein, a “combination” of multiple different polymers can refer to a blend of homopolymers, a copolymer made up of the different polymers or monomers thereof, or adjacent layers of the different polymers. In certain examples, the polymeric binder of the protective coating layer can have a weight-average molecular weight from about 100 g/mol to about 6,000 g/mol.

In certain examples, the colorant coating layer can be a white paint. In other examples, another color of paint can be used. Examples of paints that can be used include paints available from PPG Industries, Inc. and Akzo Nobel.

### Foam Pattern

The foam pattern can be made by printing a foaming composition over the primer layer on the substrate. The foaming composition can include two particular types of ingredients that can react to form foam: a photoacid generator compound and a metal carbonate. The photoacid generator compound can be a chemical compound that converts to or releases an acid when exposed to radiation. In certain examples, the photoacid generator can be activated by UV radiation. Once the photoacid generator compound has been activated, the acid that is generated can react with the metal carbonate, producing carbon dioxide gas to fill cells of the foam.

In some example, the photacid generator compound can be a salt that includes an anion such as CF₃SO₃⁻, SbF₆⁻, AsF₆⁻, or PF₆⁻. The salt can further include a cation such as a sulfonium compound, a phosphonium compound, an oxonium compound, an iodinium compound, an ammonium compound, or a diazonium compound. In a particular example, the photoacid generator compound can be triphenylsulfonium triflate having the formula [(C₆H₅)₃S⁺][CF₃SO₃]. Without being bound to a particular chemical mechanism, the triphenylsulfonium triflate can undergo photodissociation when exposed to UV light (specifically having a wavelength of 233 nm) to generate triflic acid. In some examples, other photoacid generators can similarly undergo photodissociation when exposed to a suitable wavelength of radiant energy.

In further examples, the metal carbonate in the foaming composition can include sodium carbonate, sodium bicarbonate, lithium carbonate, magnesium carbonate, magnesium bicarbonate, potassium carbonate, potassium bicarbonate, zinc carbonate, barium carbonate, barium bicarbonate, calcium carbonate, calcium bicarbonate, chromium carbonate, chromium bicarbonate, nickel carbonate, nickel bicarbonate, iron carbonate, iron bicarbonate, titanium carbonate, titanium bicarbonate, or a combination thereof. In a particular example, the metal carbonate can be sodium bicarbonate.

When the foaming composition is first applied, the photoacid generator and the metal carbonate can be present in the composition in an unreacted state. When the composition is activated by exposing the composition to radiant energy, the photoacid generator can undergo photodissociation to form acid, and the acid can then react with the metal carbonate. Thus, depending on the extent of the reaction, in some cases the photoacid generator and/or the metal carbonate can be consumed in the reaction. Therefore, the final printed foam panel may not actually include the photoacid or the metal carbonate in an unreacted state. However, as used herein, “a foaming composition including a photoacid generator compound and a metal carbonate activated to form the foam pattern” refers to the final foam that may include unreacted photoacid generator compound, unreacted metal carbonate, the photodissociation products of the photoacid generator, and/or reaction products of the generated acid with the metal carbonate. In many cases, the final foam can still include some amount of unreacted photoacid generator or metal carbonate.

In addition to the photoacid generator compound and the metal carbonate, the foaming composition can also include a polymer to form the solid portion of the foam, such as the walls of cells of the foam. In some examples, the polymer in the foaming composition can include polyacrylic, polyurethane, urethane acrylates, acrylic acrylates, epoxy acrylates, or a combination thereof. In further examples, the polymer in the foaming composition can be radiation curable. Thus, applying radiation to the foaming composition can activate the photoacid generator compound and cure the polymer at the same time.

In still further examples, the foaming composition can be applied as a single composition or as multiple separate compositions. In one example, a single foaming composition can include the photoacid generator compound, the metal carbonate, and the polymer. In other examples, a first composition can include the photoacid generator and a second composition can include the metal carbonate. The polymer can be included in either or both of the compositions. Then, both the first and second compositions can be printed in the same locations on the substrate to form the foam pattern.

In certain examples, the foaming composition can include the photoacid generator compound in an amount from about 0.5 wt % to about 15 wt % with respect to the total dry weight of the foaming composition. In further examples, the amount of photoacid generator can be from about 5 wt % to about 12 wt %. Additionally, the amount of metal carbonate in the foaming composition can be from about 1 wt % to about 30 wt % or from about 10 wt % to about 25 wt % with respect to the total dry weight of the foaming composition. The foaming composition can also include the polymer in an amount from about 30 wt % to about 90 wt %, or from about 40 wt % to about 70 wt % with respect to the total dry weight of the foaming composition. The foaming composition can also include a liquid vehicle appropriate for the printing process used to print the foaming composition.

The foaming composition, whether as a single composition or multiple separate compositions, can be printed on the substrate using a variety of printing methods. In certain examples, the foaming composition can be printed by ink jet printing. For example, the foaming composition can be loaded within or fluidly coupled to an ink jet printhead to selectively print the developer fluid onto the imaging medium. As used herein, “ink jet” or “jet” refers to jetting architecture, such as ink jet architecture. Ink jet architecture can include thermal or piezo architecture. Additionally, such architecture can be configured to print varying drop sizes such as less than about 10 picoliters, less than about 20 picoliters, less than about 30 picoliters, less than about 40 picoliters, less than about 50 picoliters, etc. In some examples, the foaming composition can include a liquid vehicle appropriate for ink jet printing. The liquid vehicle can be an aqueous vehicle containing water. In certain examples, water can be present in the foaming composition in an amount of about 30 wt % or greater, about 40 wt % or greater, about 50 wt % or greater, or about 60 wt % or greater. In further examples, water can be present in an amount of at most about 99 wt % or at most about 95 wt %. In particular examples, water can be present in the foaming composition in an amount of about 30 wt % to about 99 wt %, about 40 wt % to about 98 wt %, about 50 wt % to about 95 wt %, about 60 wt % to about 93 wt %, or about 70 wt % to about 90 wt %.

Co-solvents that may be included in the foaming composition can include organic co-solvents, including alcohols (e.g., aliphatic alcohols, aromatic alcohols, polyhydric alcohols (e.g., diols), polyhydric alcohol derivatives, long chain alcohols, etc.), glycol ethers, polyglycol ethers, a nitrogen-containing solvent (e.g., pyrrolidinones, caprolactams, formamides, acetamides, etc.), and a sulfur-containing solvent. Examples of such compounds include aliphatic 1-alcohols, aliphatic 2-alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. Still other examples of suitable co-solvents include propylene carbonate and ethylene carbonate.

A single co-solvent may be used, or several co-solvents may be used in combination. When included, the co-solvent(s) can be present in total in an amount ranging from about 0.1 wt % to about 60 wt %, depending on the jetting architecture, though amounts outside of this range can also be used. In another example, the co-solvent(s) can be present in an amount from about 1 wt % to about 30 wt % or from about 1 wt % to about 20 wt % of the total weight of the foaming composition. The foaming composition can also include additional ingredients appropriate for a jettable fluid, such as dispersants, surfactants, biocides, and so on.

In other examples, the foaming composition can be printed by gravure printing, screen printing, 3D printing, or other printing processes. The foaming composition ingredients can be appropriate for each type of printing process. In some examples, a liquid vehicle can be included in the foaming composition for other printing processes. In certain examples, a foaming composition formulated for gravure printing or screen printing may have a larger solids content compared to a composition formulated for ink jetting.

Additionally, if desired, the foaming composition can include a colorant such as a pigment or a dye to provide a colored foam.

### Clear Coating Layer

The clear coating layer can be a layer of transparent radiation-cured polymer. In some examples, the clear coating layer can include a radiation-curable resin such as poly(meth)acrylic, polyurethane, urethane (meth)acrylate, (meth)acrylic (meth)acrylate, epoxy (meth)acrylate, or a combination thereof. In certain examples, the clear coating layer can be a layer of polyacrylic with a thickness from about 1 μm to about 50 μm, from about 2 μm to about 30 μm, or from about 15 μm to about 25 μm. In other examples, the clear coating layer can be a polyurethane with a thickness from about 10 μm to about 100 μm, from about 30 μm to about 75 μm, or from about 40 μm to about 50 μm.

Radiation energy can be applied to the clear coating layer to cure the radiation-curable resin. In certain examples, the clear coating layer can be cured by applying UV radiation. Curing can include exposing the layer to radiation energy at an intensity from about 500 mJ/cm² to about 2,000 mJ/cm² or from about 700 mJ/cm² to about 1,300 mJ/cm². The layer can be exposed to the radiation energy for a curing time from about 5 seconds to about 30 seconds, or from about 10 seconds to about 30 seconds. In other examples, curing can include heating at a temperature from about 50° C. to about 80° C. or from about 50° C. to about 60° C. or from about 60° C. to about 80° C. The clear coat layer can be heated for a curing time from about 5 minutes to about 40 minutes, or from about 5 minutes to about 10 minutes, or from about 20 minutes to about 40 minutes, in some examples.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “liquid vehicle” refers to a liquid fluid used to carry solids or dissolved components, e.g., pigments, dyes, polymeric solids, reactants of a fluid, etc. A wide variety of vehicles may be used with the systems and methods of the present disclosure. Such liquid vehicles may include a mixture of a variety of different agents, including, surfactants, solvents, co-solvents, anti-kogation agents, buffers, biocides, sequestering agents, viscosity modifiers, surface-active agents, water, etc.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description describes the use of pigment colorants, the term “pigment” can be used more generally to describe pigment colorants and other pigments such as organometallics, ferrites, ceramics, etc. In one specific example, however, the pigment is a pigment colorant

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### EXAMPLE

A printed foam panel for an electronic device is prepared as follows:
1) A cover substrate is formed by injection molding polycarbonate plastic. The cover substrate has a thickness of 1 mm.
2) A polyurethane primer composition is applied at a coating thickness of 10 μm using spray coating.
3) A foaming composition is ink jetted in a pattern on a portion of the cover substrate over the primer layer. The foaming composition includes 10 wt % by dry weight triphenylsulfonium triflate as the photoacid generator compound, 15 wt % by dry weight sodium bicarbonate as the metal carbonate, and a polyurethane polymer in an aqueous liquid vehicle.
4) UV light at a wavelength from 220 nm to 320 nm is applied to activate the foaming composition and form a foam pattern.
5) A clear coating layer of Raycron® UV coating (PPG Industries, Inc., Pennsylvania) is applied over the foam pattern and then cured using UV light.

What is claimed is:

1. A printed foam panel for an electronic device comprising:
a substrate;
a primer layer on the substrate;
a foam pattern on the primer layer, wherein the foam pattern covers a first portion of the substrate and leaves a second portion uncovered, the foam pattern generated from printed pattern of a foaming composition including a photoacid generator compound and a metal carbonate activated to form the foam pattern; and
a clear coating layer on the foam pattern.

2. The printed foam panel of claim 1, wherein the substrate is a cover for an electronic device comprising aluminum, magnesium, carbon fiber, glass, polypropylene, polycarbonate, polyethylene, polyamide, polyester, acrylonitrile-butadiene-styrene, or a combination thereof.

3. The printed foam panel of claim 1, wherein the substrate is a flexible polymeric film comprising polyacrylic, polymethacrylic, polyethylene terephthalate, polyimide, polyurethane, polycarbonate, polyvinyl chloride, or a combination thereof.

4. The printed foam panel of claim 1, wherein the primer layer comprises polyacrylic, polymethacrylic, polycarbonate, polyester, cyclic olefin copolymer, or a combination thereof.

5. The printed foam panel of claim 1, wherein the photoacid generator compound comprises a salt including:
an anion including CF₃SO₃⁻, SbF₆⁻, AsF₆⁻, or PF₆⁻, and
a cation including a sulfonium compound, a phosphonium compound, an oxonium compound, an iodonium compound, an ammonium compound, or a diazonium compound.

6. The printed foam panel of claim 1, wherein the metal carbonate comprises sodium carbonate, sodium bicarbonate, lithium carbonate, magnesium carbonate, magnesium bicarbonate, potassium carbonate, potassium bicarbonate, zinc carbonate, barium carbonate, barium bicarbonate, calcium carbonate, calcium bicarbonate, chromium carbonate, chromium bicarbonate, nickel carbonate, nickel bicarbonate, iron carbonate, iron bicarbonate, titanium carbonate, titanium bicarbonate, or a combination thereof.

7. The printed foam panel of claim 1, wherein the foam pattern further comprises polyacrylic, polyurethane, urethane acrylates, acrylic acrylates, epoxy acrylates, or a combination thereof.

8. The printed foam panel of claim 1, wherein the clear coating layer comprises a transparent radiation-cured polymer.

9. The printed foam panel of claim 1, further comprising a colorant coating layer between the primer layer and the foam pattern, wherein the colorant coating layer comprises a pigment and a binder.

10. An electronic device comprising:
an electronic component; and
a cover enclosing the electronic component, the cover including a printed foam pattern and comprising:
a substrate,
a primer layer on the substrate,
a foam pattern on the primer layer, wherein the foam pattern covers a first portion of the substrate and leaves a second portion uncovered, and the foam pattern generated from a printed pattern of a foaming composition including a photoacid generator compound and a metal carbonate activated to form the foam pattern, and
a clear coating layer on the foam pattern.

11. The electronic device of claim 10, wherein the electronic component generates heat and the first portion where the foam pattern is located insulates the cover from the heat.

12. The electronic device of claim 10, wherein the foam pattern is visible on an exterior surface of the cover.

13. A method of making a printed foam panel for an electronic device comprising:
applying a primer composition to a substrate to form a primer layer;
printing a foaming composition on the primer layer to form a printed pattern of the foaming composition, wherein the printed pattern covers a first portion of the substrate with the foaming composition and leaves a second portion uncovered, and wherein the foaming composition comprises a photoacid generator compound and a metal carbonate;
applying radiation to the foaming composition to generate a foam pattern from the foaming composition; and
applying a clear coating on the foam pattern.

14. The method of claim 13, wherein the foaming composition is printed by inkjet printing, rotogravure printing, screen printing, 3D printing, or a combination thereof.

15. The method of claim 13, further comprising laminating an adhesive layer and a release film to a bottom surface of the substrate, wherein the substrate includes a polymer film.
